(19) United States
(12) Patent Application Publication
(10) Pub. No.: US 2022/0043023 A1
(43) Pub. Date: Feb. 10, 2022

(54) APPARATUS WITH ROTATING DEVICE SENSING

(71) Applicant: SAMSUNG ELECTRO-MECHANICS CO., LTD., Suwon-si (KR)

(72) Inventors: Si Young KWON, Suwon-si (KR); Yong Wook KIM, Suwon-si (KR)

(73) Assignee: SAMSUNG ELECTRO-MECHANICS CO., LTD., Suwon-si (KR)

(21) Appl. No.: 17/060,574

(22) Filed: Oct. 1, 2020

(30) Foreign Application Priority Data
Aug. 5, 2020 (KR) 10-2020-0098055

(51) Int. Cl. G01P 13/04; G01B 7/30; G01D 5/20

(52) U.S. Cl. CPC G01P 13/04; G01D 5/20; G01B 7/30

(57) ABSTRACT

A rotating device sensing apparatus includes: a rotating device comprising a detection target unit; a pattern portion formed in the detection target unit in a direction of rotation of the rotating device; a first sensor disposed to face one region of the detection target unit; and a second sensor, spaced apart from the first sensor, and disposed to face another region of the detection target unit, wherein the pattern portion comprises a first pattern portion and a second pattern portion having different widths.

### CROSS-REFERENCE TO RELATED APPLICATIONS

This application claims the benefit under 35 USC 119(a) of Korean Patent Application No. 10-2020-0098055 filed on Aug. 5, 2020, in the Korean Intellectual Property Office, the entire disclosure of which is incorporated herein by reference for all purposes.

### BACKGROUND

### 1. Field

The following description relates to an apparatus with rotating device sensing.

### 2. Description of Related Art

A rotating device may be used in various devices such as a motor and a wheel switch of a wearable device. When such rotating device is small and/or thin, sensors for sensing a rotation angle of such rotating device may use technologies for sensing a fine displacement of such rotating device and the sensors may be miniaturized to reduce a space occupied by a sensing structure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a rotating device sensing apparatus includes: a rotating device comprising a detection target unit; a pattern portion formed in the detection target unit in a direction of rotation of the rotating device; a first sensor disposed to face one region of the detection target unit; and a second sensor, spaced apart from the first sensor, and disposed to face another region of the detection target unit, wherein the pattern portion comprises a first pattern portion and a second pattern portion having different widths.

The apparatus of claim 1, wherein the pattern portion may be formed by alternately forming the first and second pattern portions in the direction of rotation of the rotating device.

The first pattern portion and the second pattern portion may be connected continuously so as to form a shape of a single band having a gradually varying width.

A shape of the pattern portion in the region corresponding to a position of the first sensor and a shape of the pattern portion in the other region corresponding to a position of the second sensor may be different.

The first sensor and the second sensor may be spaced apart to have a predetermined angle with a center axis of the rotating device.

A sensing surface of the second sensor may have an angle of inclination of 45° with a sensing surface of the first sensor.

The apparatus may include a frame in which the rotating device is disposed, wherein one surface of the frame is inclinedly disposed to have a predetermined angle with another surface of the frame, and the first and second sensors are respectively disposed to have the predetermined angle with respect to an inner side surface of the one surface and an inner side surface of the other surface of the frame.

The apparatus may include a substrate for mounting the first and second sensors, wherein the substrate is bent to surround an external side surface of the one surface of the frame and an external side surface of the other surface of the frame.

The pattern portion may be formed of a metal material, and the first sensor and the second sensor may each include a sensing coil.

The first sensor and the second sensor may be respectively configured to sense changes in inductance based on a rotation of the rotating device, and the change in inductance sensed by the first sensor and the change in inductance sensed by the second sensor may have a predetermined phase difference based on a dispositional relationship between the first and second sensors.

The changes in inductance respectively sensed by the first and second sensors may correspond to either one of a sine function and a cosine function.

In another general aspect, a rotating device sensing apparatus includes: a rotating device comprising a detection target unit; a pattern portion formed in a direction of rotation of the rotating device and having a shape of a single band surrounding the detection target unit; a first sensor disposed to face one region of the detection target unit; and a second sensor, spaced apart from the first sensor, to have a predetermined angle with the first sensor.

The single band-shape of the pattern portion may have a width gradually varying in the direction of rotation of the rotating device.

A width of the pattern portion corresponding to a position of the first sensor and a width of the pattern portion corresponding to a position of the second sensor may be different.

A sensing surface of the second sensor may have an angle of inclination of 45° with a sensing surface of the first sensor.

The apparatus may include a flexible substrate, wherein the first and second sensors are mounted on a same surface of the flexible substrate.

In another general aspect, an electronic device includes: a rotating device comprising an electrically conductive pattern portion formed in a direction of rotation of the rotating device; and a first sensor and a second sensor configured to sense respective changes in induction in response to a rotation of the rotating device, and respectively disposed to face different portions of the pattern portion.

The electronic device may be a smart watch, and the rotating device may include a crown of the smart watch configured to be rotated by a user.

The pattern portion may include a wave-patterned band shape having a varying width.

Other features and aspects will be apparent from the following detailed description, the drawings, and the claims.

### BRIEF DESCRIPTION OF DRAWINGS

FIG. 1 is a perspective view of an apparatus sensing a rotating device according to one or more embodiments;

FIG. 2 is a diagram illustrating a dispositional relationship between a sensor and a rotating device according to one or more embodiments;

FIG. 3 is a diagram illustrating a shape of a pattern portion according to one or more embodiments;

FIG. 4 is a diagram illustrating a dispositional relationship between a first sensor and a second sensor of a pattern portion according to one or more embodiments;

FIG. 5 is diagrams illustrating an aspect in which widths of pattern portions corresponding to first and second sensors vary in accordance with a rotation of a rotating device according to one or more embodiments;

FIG. 6 is a graph illustrating a change in inductance sensed by first and second sensors in accordance with a rotation of a rotating device according to one or more embodiments;

FIG. 7A is a graph illustrating a change in inductance measured by a conventional apparatus for sensing a rotating body; and

FIG. 7B is a graph illustrating a change in inductance measured by an apparatus for sensing a rotating body according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after gaining an understanding of the disclosure of this application. For example, the sequences of operations described herein are merely examples, and are not limited to those set forth herein, but may be changed as will be apparent after gaining an understanding of the disclosure of this application, with the exception of operations necessarily occurring in a certain order. Also, descriptions of features that are known in the art may be omitted for increased clarity and conciseness.

The embodiments, however, may be embodied in various forms and should not be construed as limiting the scope of the present disclosure. Rather, the examples described herein have been provided merely to illustrate some of the many possible ways of implementing the methods, apparatuses, and/or systems described herein that will be apparent after an understanding of the disclosure of this application. Further, the embodiments are provided to fully describe the present disclosure to one of ordinary skill in the art. It should be understood that although various embodiments of the present invention are different from each other, they need not be mutually exclusive. For example, specific shapes, structures, or features described in the present specification may be modified for another embodiment without departing from the spirit and scope of the present invention.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

Due to manufacturing techniques and/or tolerances, variations of the shapes illustrated in the drawings may occur. Thus, the examples described herein are not limited to the specific shapes illustrated in the drawings, but include changes in shape that occur during manufacturing

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

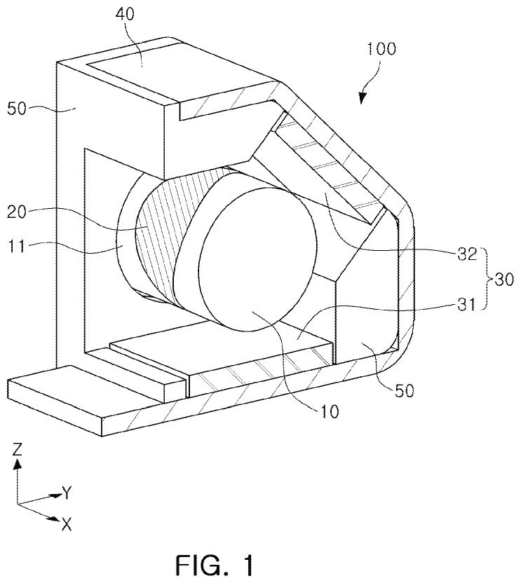

FIG. 1 is a perspective view of an apparatus sensing a rotating device according to one or more embodiments.

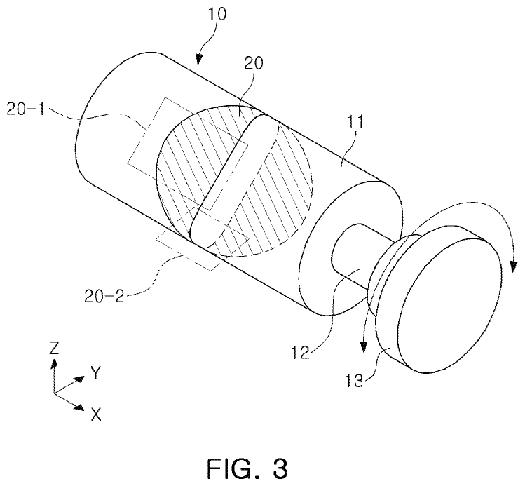

An apparatus 100 configured to sense a rotating device according to one or more embodiments may include a rotating device 10, a pattern portion 20 and a sensor 30. The pattern portion 20 may include first and second pattern portions 20-1 and 20-2 (e.g., examples of which are further described below with reference to FIGS. 3-5), having different widths, and the sensor 30 may include a first sensor 31 and a second sensor 32. The apparatus 100 may further include a substrate 40 and a frame 50.

As illustrated in FIG. 1, the rotating device 10 may include a detection target unit 11. In an example, the rotating device 10 may include a rotating member having a cylindrical shape and the detection target unit 11 on a side surface of the cylindrical shape. The rotating device 10 and the detection target unit 11 may be formed of various materials, such as an electrically insulating material. For example, the rotating device 10 and the detection target unit 11 may be formed of a resin material, such as plastic, or the like.

The detection target unit 11 provided on a side surface of the cylindrical shape is merely an example, and in another example the detection target unit 11 may be provided on a side surface of a different shape within a range not disturbing a rotation of the rotating device 10. When the detection target unit 11 is provided on the side surface of the different shape, a shape of the pattern portion 20 formed in the detection target unit 11 may vary in accordance with (e.g., based on) a radius of each point of the detection target unit 11.

The detection target unit 11 may rotate clockwise or counterclockwise in accordance with clockwise or counterclockwise rotation of the rotating device 10. The rotation of the rotating device 10 may be carried out by an external force applied to a rotation application unit 13 (illustrated in FIG. 3, for example), which will be further described below. That is, as a user of an electronic device (e.g., the apparatus 100 or an electronic device including the apparatus 100) applies the external force by rotating the rotation application unit 13 clockwise or counterclockwise, a rotation shaft 12 (illustrated in FIG. 3, for example) connected to the rotation application unit 13 and the detection target unit 11 may rotate in a same direction and at a same speed as the rotation application unit 13.

As illustrated in FIG. 1, the pattern portion 20 may be formed in the detection target unit 11 in the direction of rotation of the rotating device 10. The pattern portion 20 may be formed of a material having electrical conductivity. For example, the pattern portion 20 may be formed of a metal material and by plating the pattern portion 20 on the detection target unit 11.

Various methods may be used to plate the pattern portion 20. As an example, a laser direct structuring (LDS) method may be used to plate the pattern portion 20. A process of etching the detection target unit 11 to fit to the shape of the pattern portion 20 may be included or printing to allow the pattern portion 20 formed of a metal material to be protrude from a surface of the detection target unit 11 without etching the detection target unit 11, depending on a plating method.

According to one or more embodiments, the pattern portion 20 may have a shape of a single band surrounding the detection target unit 11. In a conventional apparatus for sensing a rotating device, two or more patterns, separated from each other, may be disposed side by side. However, such conventional apparatus for sensing a rotating device is problematic in that a length of a detection target unit of a rotating device of such conventional apparatus may be increased in a lateral direction (X-direction in FIG. 1) by the two or more patterns, thereby increasing an overall length and size of such conventional apparatus.

One or more embodiments of the present disclosure solve such problem. For example, in one or more embodiments, when the detection target unit 11 is provided with the pattern portion 20 having a single band shape, the apparatus 100 for sensing a rotating device may have a reduced length in the lateral direction and may thus be miniaturized. Example shapes of the pattern portion 20 are illustrated in FIGS. 3 to 5 and thus will be further described below.

The apparatus 100 for sensing a rotating device according one or more embodiments may include a first sensor 31 and a second sensor 32. The first sensor 31 may be disposed to oppose or face one region of the detection target unit 11, and the second sensor 32 may be disposed to oppose or face another region of the detection target unit 11, while being spaced apart from the first sensor 31.

The first sensor 31 and the second sensor 32 may each include a sensing coil. For example, the sensing coil may be a wound inductor coil. Alternately, the sensing coil may be a PCB coil pattern formed on the substrate 40. The sensing coil of the first sensor and that of the second sensor 32 may lead to a change in inductance in accordance with the rotation of the rotating device 10.

For example, a shape of the pattern portion 20 corresponding to the first sensor 31 and that of the second sensor 32 may vary according to the rotation of the rotating device 10. For example, the pattern portion 20 may be formed to have a width varying in accordance with the direction of rotation of the rotating device 10. Inductance, generated in the sensing coil, may vary due to the pattern portion 20 formed of a metal material, in accordance with the rotation of the detection target unit 11 provided in the rotating device 10. The first and second sensors 31 and 32 may sense a degree of the change in inductance generated in the respective sensing coil to detect a rotation angle of the rotating device 10.

As used herein, the term “rotation angle” refers to a degree of rotation of the rotating device 10 clockwise or counterclockwise while having a central shaft of the cylinder as a rotation shaft. When a rotation is not applied to the rotating device 10 by a user, the rotating device 10 may maintain a static state. In this case, the static state of the rotating device 10 may be set as a reference point of a rotation angle calculation. When a rotation is applied by the user, each point of a side surface of the rotating device 10 may move by a certain angle from each reference point.

In this case, a rotation angle of the rotating device 10 may be calculated by sensing a shape before and after a change of the pattern portion 20 formed in the detection target unit 11 resulting from the rotation. For example, a point vertically opposing a central point of the first sensor 31 may be set as a reference point in the detection target unit 11, and a rotation angle may be measured by the first sensor 31 sensing a change in the shape of the pattern portion 20, relevant to the reference point. However, this is merely an example, and various methods involving changing the reference point may be used to calculate the rotation angle.

A shape of the pattern portion 20 corresponding to a position of the first sensor 31 and a shape of the pattern portion 20 corresponding to a position of the second sensor 32 may be different. For example, when the pattern portion 20 has a single band shape, a width of the pattern portion 20 corresponding to the position of the first sensor and a width of the pattern portion 20 corresponding to the position of the second sensor may be different.

In this regard, an aspect of the inductance change sensed by the first and second sensors 31 and 32 may vary in accordance with the rotation of the detection target unit 11. For example, an inductance value (hereinafter, “sensed value”) sensed by the first sensor 31 and that of the second sensor 32 may have a phase difference.

The apparatus 100 according to one or more embodiments may determine the rotation angle by detecting the sensing values of the first sensor 31 and the second sensor 32 having a different phase. Accordingly, the rotation angle of the rotating device 10 may be continuously detected even when a malfunction or a noise occurs in any one of the sensors, and a sensing error of the sensors may be minimized.

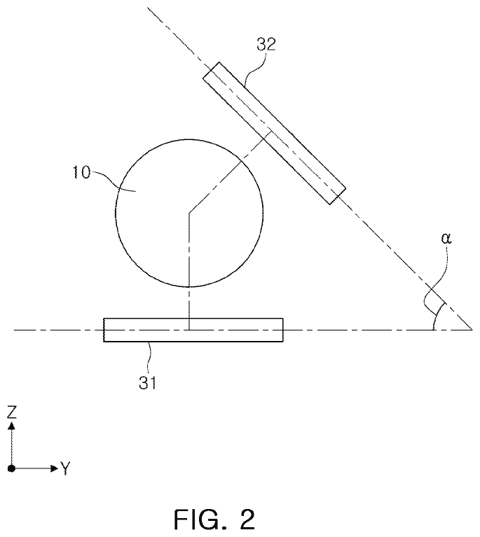

Further, the first and second sensors 31 and 32 may be spaced apart to form a predetermined angle with respect to each other. For example, as illustrated in FIG. 1, the first and second sensors 31 and 32 may be spaced apart so as to have a predetermined angle with respect to the center axis of the rotating device 10. In this regard, the first and second sensors 31 and 32 oppose or face different regions of the detection target unit 11. A specific description of the predetermined angle formed by the first and second sensors 31 and 32 will be further described below with reference to FIG. 2.

The apparatus 100 according to one or more embodiments may include the substrate 40 for mounting the first sensor 31 and the second sensor 32. The substrate 40 may be a flexible printed circuit substrate (FPCB), but is not limited thereto. That is, the substrate 40 may be any substrate having a structure in which at least one metal layer and at least one wiring layer may be alternately stacked.

In addition, a sensing circuit including an integrated circuit may be mounted on the substrate 40. In this case, the sensing circuit may be electrically connected to the first and second sensors 31 and 32. The sensing circuit may detect a change of the inductance generated in the sensing coil of the sensor 30 to determine rotation information of the rotating device 10. The “rotation information” may include at least one of a direction of rotation, a rotation angle, and an angular speed.

The apparatus 100 according to one or more embodiments may further include the frame 50, into which the rotating device 10 is inserted. The frame 50 may form an external frame of the apparatus 100 and may include elements of the apparatus thereinside.

The frame 50 may have various shapes, and as illustrated in FIG. 1, one surface of the frame may be inclined to have a predetermined angle with respect to another surface of the frame. Further, the first and second sensors 31 and 32 may be disposed to have a predetermined angle with respect to each other on an inner surface of the one surface and an inner surface of the other surface of the frame 50. That is, an angle of inclination formed by the two surface of the frame 50 may be identical to an angle of inclination formed by sensing surfaces of the two sensors 31 and 32. For reference, the term “sensing surface” of the sensor described herein refers to a surface on which the sensing coil opposes or faces the detection target unit 11 of the rotating device 10 in a horizontal direction.

As illustrated in FIG. 1, the frame 50 may include regions having different thicknesses in accordance with dispositions of the elements provided inside or outside thereof. For example, a thickness of the frame 50 in a region in which the first and second sensors 31 and 32 are disposed may be smaller than that in an edge region between the two sensors 31 and 32. Further, a thickness of the frame 50 in a region in which the substrate 40 is disposed may be smaller than that in a region in which no substrate 40 is disposed.

Accordingly, the frame may allow the elements including the sensor 30 and the substrate 40 to sit stably inside or outside the frame 50.

Meanwhile, the frame 50 between the first sensor 31 and the second sensor 32 may be inwardly formed to be thick while also independently separating the two sensors 31 and 32, such that the inductance value generated by the sensors may be more accurately measured by blocking an electromagnetic interruption between the first sensor 31 and the second sensor 32.

As previously described, a length of the detection target unit 11 in the lateral direction (X-direction in FIG. 1) may be reduced when the pattern portion 20 according to one or more embodiments has the single band shape. In this regard, the length in the lateral direction and an overall volume of the frame 50 may be reduced, and a space occupied by the apparatus 100 when installed in an electronic device (e.g., a digital or smart watch) may be reduced.

The substrate 40 according to one or more embodiments may be formed to surround at least a portion of the external side surface of the frame 50 as illustrated in FIG. 1. For example, the substrate 40 may be bent to surround an external side surface of the one surface on which the first sensor 31 is disposed and an external side surface of the other surface on which the second sensor 32 is disposed. In this example, the substrate may be a flexible printed circuit substrate (FPCB). Further, the first and second sensors 31 and 32 may be mounted on a same surface.

FIG. 2 is a diagram illustrating a dispositional relationship between a sensor and a rotating device (e.g., the rotating device illustrated in FIG. 1) according to one or more embodiments.

As illustrated in FIG. 2, the first sensor 31 and the second sensor 32 may be spaced apart to have a predetermined angle with respect to a center axis of the rotating device 10. In this example, the predetermined angle formed by the sensing surfaces of the first and second sensors 31 and 32 may vary, and may be, for example, 45°.

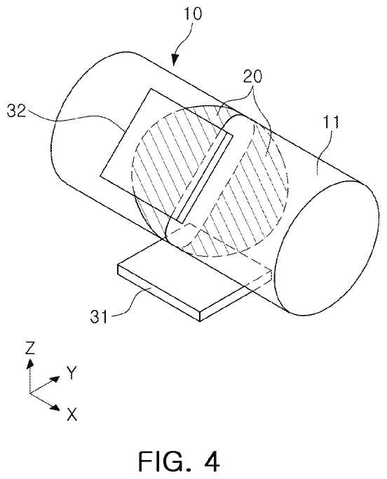

An angle a may be determined in accordance with the shape of the pattern portion 20 formed in the detection target unit 11. That is, the shape of the pattern portion 20 corresponding to the positions of the first and second sensors 31 and 322 vary in accordance with the rotation of the rotating device 10. The angle a, formed by the sensing surfaces of the two sensors 31 and 32 may be determined depending on a cycle of the shape change. Example shapes of the pattern portion 20 are illustrated in FIGS. 3 and 4, and thus will be further described below with reference thereto.

FIG. 3 is a diagram illustrating a shape of a pattern portion according to one or more embodiments, and FIG. 4 is a diagram illustrating a dispositional relationship between a first sensor and a second sensor of a pattern portion (e.g., the pattern portion illustrated in FIG. 3) according to one or more embodiments.

Referring to FIG. 3, a rotating device 10 may include a detection target unit 11, a rotation shaft 12 and a rotation application unit 13. The rotating device 10 may be provided with a rotation member having a cylindrical shape at one end, the rotation application unit 13 on another end, and the rotation shaft 12 between the rotation member and the rotation application unit 13. Further, the detection target unit 11 may be provided on a side surface of the rotation member.

When a user of an electronic device applied with, or of, the apparatus 100 according to one or more embodiments of the present disclosure rotates the rotation application unit 13 clockwise or counterclockwise, the rotation shaft 12 connected to the rotation application unit 13 may rotate together in a same direction at a same speed. As the entire rotating device 10 rotates in accordance with the rotation of the rotation shaft 12, the detection target unit 11 provided on the one end of the rotating device 10 may also rotate in the same direction at the same speed.

The pattern portion 20 according to an one or more embodiments of the present disclosure may have a single band shape as illustrated in FIGS. 3 and 4. In this example, the pattern portion 20 may include a first pattern portion 20-1 and a second pattern portion 20-2 having different widths. For example, the pattern portion 20 may include the first pattern portion 20-1 having a larger width than an average width of the pattern portion 20 and the second pattern portion 20-2 having a smaller width than the average width of the pattern portion 20.

Referring to FIGS. 2 to 4, the sensing surface of each of the first and second sensors 31 and 32 may be disposed to have a predetermined angle a with respect to each other. In this example, a shape of the pattern portion 20 corresponding to a position of the first sensor 31 may be different from a shape of the pattern portion 20 corresponding to a position of the second sensor 32.

For example, as illustrated in FIG. 4, the first sensor 31 may be disposed to be close to the second pattern portion 20-2 while the second sensor 32 may be disposed to be close to the first pattern portion 20-1. When the detection target unit 11 rotates clockwise, the pattern portion 20 corresponding to the position of the first sensor 31 may change in a direction in which the width thereof increases, while the pattern portion 20 corresponding to the position of the second sensor 32 may change in a direction in which the width thereof is reduced. That is, the direction in which inductance is detected in the first sensor 31 may be opposite to the direction in which inductance is detected in the second sensor 32.

For example, a frequency form of an inductance value sensed by the first sensor 31 and a frequency form of an inductance value sensed by the second sensor 32 may have an identical cycle and different phases changes. That is, there may be a phase difference between the sensing values detected by the first and second sensors 31 and 32 in accordance with the rotation of the detection target unit 11.

In this example, the sensing value detected by the first and second sensors 31 and 32 may have a predetermined phase difference in accordance with a dispositional relationship of the two sensors 31 and 32. As an example, the pattern portion 20 of the detection target unit 11 may be characterized in that the first and second pattern portions 20-1 and 20-2 are alternately stacked or formed in the direction of rotation of the rotating device 10. As previously described, when the first and second pattern portions 20-1 and 20-2 are alternately stacked or formed twice in the direction of rotation of the rotating device 10, and the predetermined angle a formed by the first and second sensors 31 and 32 is determined to be 45°, the sensing value detected by each sensor may have a phase difference of 90°.

The apparatus 100 according to one or more embodiments of the present disclosure may determine a rotation angle more precisely by simultaneously detecting the sensing values of the first and second sensors 31 and 32 having the phase difference, as compared to a conventional apparatus in which only one sensing value is detected. Further, as there is the predetermined phase difference of 90° between the sensing values, each of the sensing values may be easily distinguished and detected. Accordingly, even when there is a malfunction or a noise generated in any one of the sensors, the sensing value of the other sensor may be used to continuously determine the rotation angle. In an example, the apparatus 100 may be, or be included in, an electronic device such as a smart watch and may correspond to a digital crown of the electronic device.

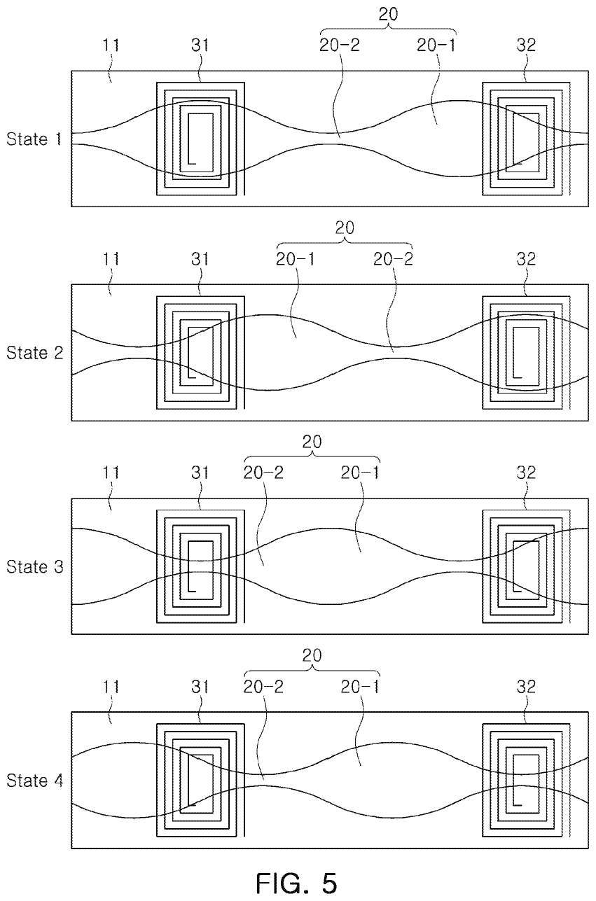

FIG. 5 is diagrams illustrating an aspect in which widths of pattern portions corresponding to first and second sensors vary in accordance with a rotation of a rotating device according to one or more embodiments.

Referring to FIG. 5, a pattern portion 20 may be formed in a detection target unit 11, and the pattern portion may include a first pattern portion 20-1 and a second pattern portion 20-2 having different widths. Additionally, the first pattern portion 20-1 and the second pattern portion 20-2 may be connected continuously such that a single band shape is formed to have a gradually varying width. For example, the pattern portion 20 may include the first pattern portion 20-1 and the second pattern portion 20-2 connected continuously twice to form a wave patterned shape as illustrated in FIG. 5. For example, the pattern portion 20 may include two first pattern portions 20-1 and two second pattern portions 20-2.

In this example, the first and second sensors 31 and 32 may be disposed to overlap with regions having different shapes. According to a rotation of the rotating device 10, a surface area of the pattern portion 20 overlapped with each of the sensors 31 and 32 changes, thereby enabling the first and second sensors 31 and 32 to detect a change in inductance.

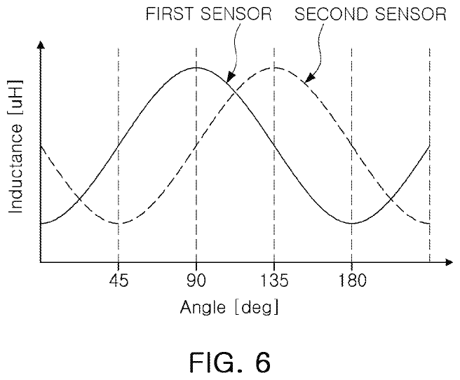

A graph illustrating an aspect in which the inductance changes as the overlapped surface area of the sensor 30 and the pattern portion 20 changes will be described below with reference to FIG. 6.

FIG. 6 is a graph illustrating a change in inductance sensed by first and second sensors in accordance with a rotation of a rotating device according to one or more embodiments.

Referring to FIG. 6, an inductance value sensed by a first sensor 31 and an inductance value sensed by a second sensor 32 may include a frequency changing in accordance with a rotation of a rotating device 10. That is, as a rotation angle of the rotating device 10 varies, each inductance value may vary while having a consistent wave form. Frequency forms of the inductance values of the two sensors 31 and 32 may have an identical cycle and different phases changes.

For reference, in the graph of FIG. 6, a starting point at which the rotation angle is 0° may correspond to State 1 illustrated in FIG. 5, a point at which the rotation angle is 45° may correspond to State 2 illustrated in FIG. 5, a point at which the rotation angle is 90° may correspond to State 3 illustrated in FIG. 5, and a point at which the rotation angle is 135° corresponds to State 4 illustrated in FIG. 5.

For example, referring to FIGS. 5 and 6 together, the first sensor 31 may be disposed to overlap with the center portion a first pattern portion 20-1 in State 1, while the second sensor 32 may be disposed to overlap with a right side of a first pattern portion 20-1 in State 1. In State 1, when the center portion a first pattern portion 20-1 the pattern portion 20 formed of a metal material is adjacent to the first sensor 31 including a sensing coil, a current may be applied to the pattern portion 20 by magnetic flux generated in the sensing coil, and the magnetic flux may be generated in the pattern portion 20 by the current applied to the pattern portion 20. In this example, the magnetic flux generated in the pattern portion 20 may cancel the magnetic flux of the sensing coil of the first sensor 31, thereby reducing the inductance of the sensing coil of the first sensor 31. Accordingly, based on 0° of FIG. 6, corresponding to State 1, the inductance of the first sensor 31 may have a low level value whereas that of the second sensor 32 may have a high level value.

After State 1, the detection target unit 11 may rotate in a direction from left to right to be in State 2. In State 2, the first sensor 31 may overlap with a left side of the first pattern portion 20-1, and the second sensor 32 may overlap with the center portion of the first pattern portion 20-1. That is, when State 1 changes to State 2, an area of the pattern portion 20 overlapped with the first sensor 31 may be reduced, and an area of the pattern portion 20 overlapped with the second sensor 32 may increase. Accordingly, based on 45° of FIG. 6 corresponding to State 2, the inductance of the first sensor 31 may increase to a high level and the inductance of the second sensor 32 may be reduced to a low level as compared to State 1.

After State 2, the detection target unit 11 may rotate in a direction from left to right to be in State 3. In State 3, the first sensor 31 may overlap with the center portion of the second pattern portion 20-2, and the second sensor 32 may overlap with the left side of the first pattern portion 20-1. That is, when State 2 changes to State 3, an area of the pattern portion 20 overlapped with the first sensor 31 may be reduced, and an area of the pattern portion 20 overlapped with the second sensor 32 may also be reduced. Accordingly, based on 90° of FIG. 6 corresponding to State 3, the inductance of the first sensor 31 may increase to a high level and the inductance of the second sensor 32 may also increase to a high level as compared to State 2.

After State 3, the detection target unit 11 may rotate in a direction from left to right to be in State 4. In State 4, the first sensor 31 may overlap with a right side of the first pattern portion 20-1, and the second sensor 32 may overlap with the center portion of the second pattern portion 20-2. That is, when State 3 changes to State 4, an area of the pattern portion 20 overlapped with the first sensor 31 may increase, and an area of the pattern portion 20 overlapped with the second sensor 32 may be reduced. Accordingly, based on 135° of FIG. 6 corresponding to State 4, the inductance of the first sensor 31 may be reduced to a low level and the inductance of the second sensor 32 may increase to a high level as compared to State 3.

Further, as illustrated in FIG. 5, when the pattern portion 20 has a single band shape having a gradually varying width, the inductance value sensed by each of the sensors 31 and 32 may show a curved frequency wave form. That is, when the surface areas of the pattern portion 20 overlapped with the first and second sensors 31 and 32 gradually change, the resulting change of the inductance may show a continuous wave form.

In this example, as illustrated in FIGS. 1 to 5, when the first and second pattern portions 20-1 and 20-2 are alternately stacked or formed twice in the direction of rotation of the rotating device 10, and the predetermined angle a formed by the first and second sensors 31 and 32 is determined to be 45°, the sensing value detected by each sensor may have a phase difference of 90°. In this regard, the inductance change sensed by the first and second sensors 31 and 32 may show a sine function or a cosine function. Accordingly, in an example, the pattern portion 20 may be constructed with the band shape having the gradually varying width such that the sine function or the cosine function of the inductance change is generated.

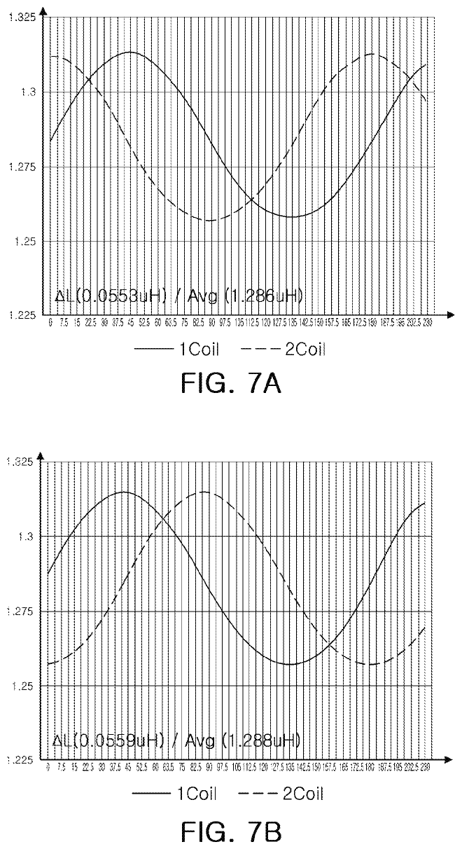

FIG. 7A is a graph illustrating a change in inductance measured by a conventional apparatus for sensing a rotating body, and FIG. 7B is a graph illustrating a change in inductance measured by an apparatus for sensing a rotating body according to one or more embodiments of the present disclosure.

For example, FIG. 7A is experimental data showing a measured change of an inductance detected by each sensor when two pattern portions are disposed in a conventional detection target unit side by side and two sensors are correspondingly disposed side by side, and FIG. 7B is experimental data showing a measured change of an inductance detected by each sensor 31 and 32 when the pattern portion 20 having a single band shape is formed in the detection target unit 11 of one or more embodiments of the present disclosure and the two sensors 31 and 32 forming a predetermined angle with respect to each other are disposed in different regions to oppose or face each other.

As illustrated in FIGS. 7A and 7B, even when rotation is detected by the apparatus for sensing a rotating device according to one or more embodiments of the present disclosure, it may be confirmed that a wave forms of a frequencies having an identical cycle and different phases are generated. Further, by effectively determining a predetermined angle formed by the first and second sensors 31 and 32 in accordance with the shape of the pattern portion 20, two wave forms may be implemented to have a phase difference of 90°, facilitating a correction of an error caused by a malfunction or a noise.

Meanwhile, as illustrated in FIG. 7B, a changed amount ΔL of the inductance and an average inductance value Avg measured by the apparatus 100 of one or more embodiments of the present disclosure is greater than the conventional apparatus for sensing a rotating device illustrated in FIG. 7A. Such a result is due to reduced occurrence of an electro-magnetic flux cross talk by physically separating a sensing coil of the first sensor 31 and a sensing coil of the second sensor 32.

That is, in contrast to the conventional apparatus, the apparatus according to one or more embodiments of the present disclosure may include the first and second sensors 31 and 32 disposed to form a predetermined angle with respect to each other, leading to an effect of increased inductance change ΔL and average inductance value Avg. In this regard, an amplification of the sensing value is increased as compared to the conventional case, thereby enabling the rotation angle of the rotating device 10 to be detected more precisely compared to the conventional apparatus.

According to one or more embodiments of the present disclosure, a size and a manufacturing cost of an apparatus for sensing a rotating device may be reduced.

Further, according to one or more embodiments, a rotation angle of a rotating device may be precisely detected.

According to one or more embodiments, a sensing error of a sensor may be minimized.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rotating device sensing apparatus, comprising:
a rotating device comprising a detection target unit;
a pattern portion formed in the detection target unit in a direction of rotation of the rotating device;
a first sensor disposed to face one region of the detection target unit; and
a second sensor, spaced apart from the first sensor, and disposed to face another region of the detection target unit,
wherein the pattern portion comprises a first pattern portion and a second pattern portion having different widths.

2. The apparatus of claim 1, wherein the pattern portion is formed by alternately forming the first and second pattern portions in the direction of rotation of the rotating device.

3. The apparatus of claim 1, wherein the first pattern portion and the second pattern portion are connected continuously so as to form a shape of a single band having a gradually varying width.

4. The apparatus of claim 1, wherein a shape of the pattern portion in the region corresponding to a position of the first sensor and a shape of the pattern portion in the other region corresponding to a position of the second sensor are different.

5. The apparatus of claim 1, wherein the first sensor and the second sensor are spaced apart to have a predetermined angle with a center axis of the rotating device.

6. The apparatus of claim 5, wherein a sensing surface of the second sensor has an angle of inclination of 45° with a sensing surface of the first sensor.

7. The apparatus of claim 1, further comprising a frame in which the rotating device is disposed,
wherein one surface of the frame is inclinedly disposed to have a predetermined angle with another surface of the frame, and
the first and second sensors are respectively disposed to have the predetermined angle with respect to an inner side surface of the one surface and an inner side surface of the other surface of the frame.

8. The apparatus of claim 7, further comprising a substrate for mounting the first and second sensors,
wherein the substrate is bent to surround an external side surface of the one surface of the frame and an external side surface of the other surface of the frame.

9. The apparatus of claim 1, wherein
the pattern portion is formed of a metal material, and
the first sensor and the second sensor each comprise a sensing coil.

10. The apparatus of claim 1, wherein
the first sensor and the second sensor are respectively configured to sense changes in inductance based on a rotation of the rotating device, and
the change in inductance sensed by the first sensor and the change in inductance sensed by the second sensor have a predetermined phase difference based on a dispositional relationship between the first and second sensors.

11. The apparatus of claim 10, wherein the changes in inductance respectively sensed by the first and second sensors correspond to either one of a sine function and a cosine function.

12. A rotating device sensing apparatus, comprising:
a rotating device comprising a detection target unit;
a pattern portion formed in a direction of rotation of the rotating device and having a shape of a single band surrounding the detection target unit;
a first sensor disposed to face one region of the detection target unit; and
a second sensor, spaced apart from the first sensor, to have a predetermined angle with the first sensor.

13. The apparatus of claim 12, wherein the single band-shape of the pattern portion has a width gradually varying in the direction of rotation of the rotating device.

14. The apparatus of claim 13, wherein a width of the pattern portion corresponding to a position of the first sensor and a width of the pattern portion corresponding to a position of the second sensor are different.

15. The apparatus of claim 12, wherein a sensing surface of the second sensor has an angle of inclination of 45° with a sensing surface of the first sensor.

16. The apparatus of claim 12, further comprising a flexible substrate, wherein the first and second sensors are mounted on a same surface of the flexible substrate.

17. An electronic device, comprising:
a rotating device comprising an electrically conductive pattern portion formed in a direction of rotation of the rotating device; and
a first sensor and a second sensor configured to sense respective changes in induction in response to a rotation of the rotating device, and respectively disposed to face different portions of the pattern portion.

18. The device of claim 17, wherein the electronic device is a smart watch, and the rotating device comprises a crown of the smart watch configured to be rotated by a user.

19. The device of claim 17, wherein the pattern portion comprises a wave-patterned band shape having a varying width.
